(19) United States
(12) Patent Application Publication
(10) Pub. No.: US 2015/0300480 A1
(43) Pub. Date: Oct. 22, 2015

(54) Transmission Sump Screen

(71) Applicant: AVL Powertrain Engineering, Inc., Plymouth, MI (US)

(72) Inventor: Gregory MORDUKHOVICH, Bloomfield Hills, MI (US)

(21) Appl. No.: 14/681,245

(22) Filed: Apr. 8, 2015

Related U.S. Application Data
(60) Provisional application No. 61/980,233, filed on Apr. 16, 2014.

(51) Int. Cl. F16H 57/04

(52) U.S. Cl. CPC F16H 57/0404; F16H 57/0436; F16H 57/0452

(57) ABSTRACT

A transmission sump screen for disposition in a transmission sump is disclosed. The transmission sump screen includes a mesh of viscosity sensitive orifices providing a predetermined permeability to selectively segregate the transmission sump into a first volume and a second volume depending upon a transmission fluid temperature. Transmission fluid is only drawn from the first volume until a threshold temperature is reached. The transmission sump screen includes a first portion having an outside edge abutting the transmission sump and an inner edge spaced from the outside edge to define a neck region of the first volume having a first periphery. The transmission sump screen includes a second portion extending downwardly from the inner edge of the first portion to a lower edge abutting the transmission sump to define a lower region of the first volume having a second periphery that is larger than the first periphery.

### CROSS-REFERENCE TO RELATED APPLICATIONS

This application claims the benefit of U.S. Provisional Application No. 61/980,233, filed on Apr. 16, 2014. This application is related to U.S. patent application Ser. No. ______ (docket no. 7971-000059-US and entitled “Sump Having Temperature-Controlled Jalousie Divider”), filed on the same day as this application. The entire disclosures of the above applications are incorporated herein by reference.

### FIELD

The present disclosure generally relates to the design of transmissions, including without limitation, transmissions used in vehicle drivetrains. Such transmissions generally include a transmission sump that collects transmission fluid. In accordance with the present disclosure, a transmission sump screen for disposition in such a transmission sump is described.

### BACKGROUND

This section provides background information related to the present disclosure which is not necessarily prior art.

Due to an increasing desire for improved fuel economy in automobiles and other vehicles, transmissions have been developed in recent years featuring a large number of forward gears to allow for engine downsizing. Smaller engines coupled to seven, eight, and nine speed transmissions are now commonplace. Such smaller engines deliver less torque to the drivetrain and generate less heat. Accordingly, it takes considerably longer for the engine to warm up the transmission fluid that is contained within and that circulates through the transmission. Newer engines are also being equipped with engine start/stop features to improve fuel economy and emissions during city driving. Such features automatically turn off the engine when the vehicle is brought to rest and automatically starts the engine again when the accelerator is pressed and travel is resumed. With the engine turned off when the vehicle is at rest, the torque converter and/or the transmission input shaft does not rotate. Accordingly, transmission fluid does not circulate within the transmission when the vehicle is at rest. By contrast, vehicles that are not equipped with engine start/stop features circulate transmission fluid through the transmission when the vehicle is stopped and the transmission is in neutral. As a result, longer periods of time are required to warm up the transmission fluid to ideal operating temperatures in vehicles equipped with start/stop features. This is problematic because the fluid viscosity of transmission fluid varies with temperature. Specifically, the viscosity of transmission fluid generally decreases (i.e., becomes less resistant to flow or is “thinner”) as temperature increases. Low viscosity is generally favored provided that sufficient lubricity of the transmission fluid is maintained, as high viscosity (i.e. more resistant to flow or is “thicker”) leads to increased viscous drag-related losses and an attendant decrease in efficiency. These losses offset much of the efficiency gains that can be realized through engine downsizing and engine start/stop features.

New engine sumps have recently been developed to address some of these problems. One such engine sump design, also developed by the inventor of the subject matter presently disclosed, is discussed in U.S. Patent Application Publication 2013/0312696 entitled “Temperature-Controlled Segregation of Hot and Cold Oil in a Sump of an Internal Combustion Engine.” The engine sump disclosed in this reference includes a porous separator disposed in the engine sump for separating the engine sump into hot and cold oil volumes during cold starting. The porous separator is arranged to create a trough-like volume that receives an engine oil pickup. The engine oil in this trough-like volume is isolated from cold engine oil disposed in the rest of the engine sump until the temperature of the cold engine oil is raised to a temperature where its viscosity permits passage through the porous separator. Accordingly, the temperature of the circulating engine oil can be raised in a quicker manner after cold starts. However, the particular configuration of the porous separator disclosed in this reference is not well suited for use in other applications such as in transmission sumps.

Engine sumps are relatively deep in comparison to transmission sumps, with the typical engine sump being about twice as deep as the typical transmission sump. Further, the volumetric capacities and residence times of engine sumps and transmission sumps differ considerably as do the viscosities of engine oil versus transmission fluid. Accordingly, the trough-like geometry of the porous separator of the above noted reference would not work well in a transmission sump because it would not provide an appropriate volumetric capacity adjacent the fluid pickup. Also, appropriate residence time for the transmission fluid would not be achieved and starvation of the fluid pickup would become more likely. What is needed is a new transmission sump design that can selectably segregate a transmission sump into two volumes to minimize warm up times for the transmission fluid without compromising the supply of the transmission fluid to the fluid pickup for circulation.

### SUMMARY

This section provides a general summary of the disclosure, and is not a comprehensive disclosure of its full scope or all of its features.

The subject disclosure provides a transmission sump screen for disposition in a transmission sump that selectively segregates the transmission sump into two volumes to minimize warm up times for circulating transmission fluid. The geometry of the transmission sump screen provides proper residences times for the transmission fluid and resists pickup starvation. The transmission sump screen includes a mesh of discrete viscosity sensitive orifices. Each discrete viscosity sensitive orifice has an orifice size that provides a predetermined permeability, where the transmission fluid cannot flow through the transmission sump screen if the transmission fluid temperature is below a threshold temperature. Thus, the transmission sump screen selectively segregates the transmission sump into a first volume around the fluid pickup and a second volume that is disposed adjacent the side wall. When the transmission fluid temperature is below the threshold temperature, the transmission sump screen acts as a barrier isolating the transmission fluid contained within the second volume from the transmission fluid contained within the first volume. With the first volume surrounding the fluid pickup, only the transmission fluid contained within the first volume is circulated when transmission fluid temperatures are below the threshold temperature.

The transmission sump screen includes a first portion that has an outside edge abutting the transmission sump and an inner edge spaced from the outside edge. The first portion of the transmission sump screen defines a neck region of the first volume. The neck region of the first volume has a first periphery, which may coincide with the length or circumference of the inner edge. The transmission sump screen further includes a second portion extending downwardly from the inner edge of the first portion to a lower edge abutting the transmission sump to define a lower region of the first volume. The lower region of the first volume has a second periphery, which may coincide with the length or perimeter of the lower edge, that is larger than the first periphery such that the neck region of the first volume is narrower than the lower region of the first volume. Accordingly, the first volume becomes wider moving from the inner edge of the first portion of the transmission sump screen to the lower edge of the second portion of the transmission sump screen.

In accordance with another aspect of the subject disclosure, each discrete viscosity sensitive orifice in the mesh of discrete viscosity sensitive orifices has an orifice size selected to prevent or obstruct the flow of transmission fluid from the second volume to the first volume when the transmission fluid temperature is below a threshold temperature. In accordance with this aspect of the disclosure, the orifice size is selected to be 1 millimeter to 2 millimeters, a range that is specifically tailored to the viscosity of transmission fluid, which is a function of the transmission fluid temperature.

Advantageously, the transmission fluid contained within the first volume is warmed to its operating temperature more quickly such that a hot zone of transmission fluid is created within the transmission sump that is co-extensive with the first volume. The second volume thus designates a cold zone and the transmission fluid contained in the second volume is not circulated until it reaches or exceeds the threshold temperature and can pass through the transmission sump screen and flow to the fluid pickup. Accordingly, the total volumetric capacity of the transmission sump is only utilized when the transmission fluid temperature of the transmission fluid in the second volume meets or exceeds the threshold temperature. Further, the widening geometry of the lower region of the first volume, as defined by the first and second portion of the transmission sump screen, gives the first volume sufficient volumetric capacity adjacent the fluid pickup despite the shallowness of the transmission sump. This ensures proper transmission fluid circulation and reduces the likelihood of starvation even under conditions where the transmission is tilted with respect to the horizontal or subject to accelerational forces due to vehicle acceleration, braking, and/or cornering.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a side perspective view of an exemplary transmission with part of a housing removed and where the exemplary transmission has been equipped with an exemplary transmission sump screen constructed in accordance with the present disclosure;

FIG. 2 is an exploded perspective view of an exemplary transmission sump illustrating the exemplary transmission sump screen shown in FIG. 1;

FIG. 3A is a perspective view of another exemplary transmission sump screen constructed in accordance with the present disclosure;

FIG. 3B is an enlarged view illustrating a portion of the exemplary transmission sump screen shown in FIG. 3A;

FIG. 4A is a perspective view of another exemplary transmission sump screen constructed in accordance with the present disclosure;

FIG. 4B is an enlarged view illustrating a portion of the exemplary transmission sump screen shown in FIG. 4A;

FIG. 5 is an exemplary transmission sump illustrating the exemplary transmission sump screen of FIG. 1 submersed in low-temperature transmission fluid; and

FIG. 6 is an exemplary transmission sump illustrating the exemplary transmission sump screen of FIG. 1 submersed in high-temperature transmission fluid.

### DETAILED DESCRIPTION

Referring to the Figures, wherein like numerals indicate corresponding parts throughout the several views, a transmission sump screen 20 is disclosed. The transmission sump screen 20 is configured for disposition inside a transmission sump 22. As used herein, the transmission sump 22 generally indicates a portion of a transmission 24 that collects and holds transmission fluid 10.

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

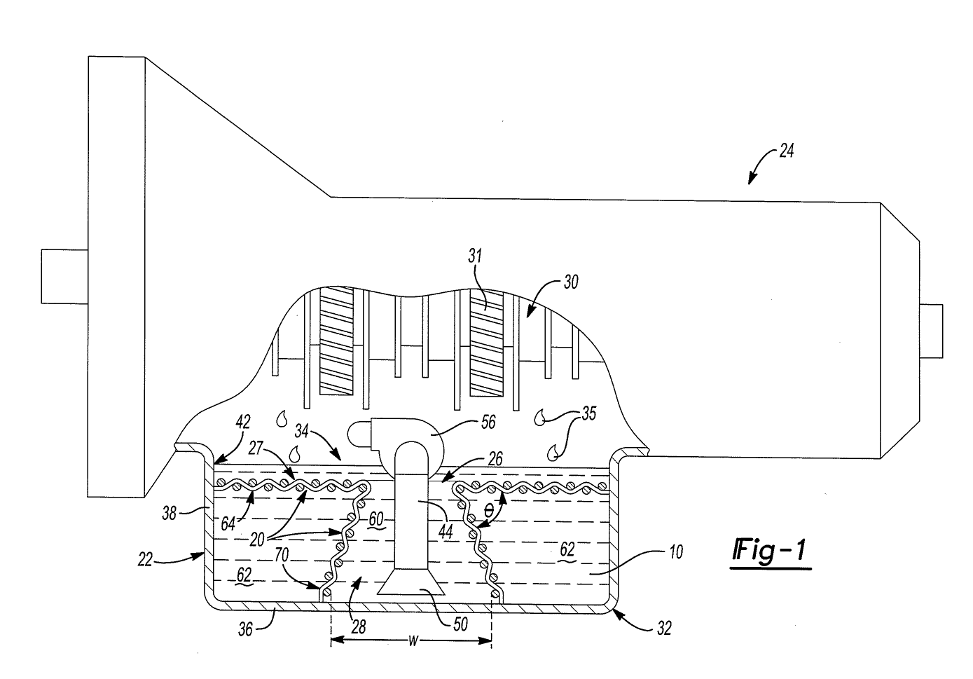

Referring to FIG. 1, the transmission 24 may be without limitation an automatic transmission, a manual transmission, a dual clutch transmission, or a continuously variable transmission. Such transmissions are commonly utilized when coupled to an engine in a vehicle, but other applications are envisioned and are within the scope of the present disclosure. The transmission 24 shown in FIG. 1 generally includes at least one gearset assembly 30 having a plurality of gears 31. The plurality of gears 31 may include one or more forward gears, reverse gears, or any combination of the two. The transmission 24 further includes a transmission sump 22, which is generally disposed beneath the at least one gearset assembly 30. The transmission sump 22 includes a housing 32 that defines a cavity 34. The housing 32 of the transmission sump 22 collects transmission fluid 10 after the transmission fluid 10 is circulated within the at least one gearset assembly 30. Specifically, gravity drains the transmission fluid 10 from the at least one gearset assembly 30 such that droplets 35 of transmission fluid 10 fall from the at least one gearset assembly 30 and into the cavity 34 of the housing 32.

Transmission fluid is typically organic, synthetic, or blended oil with particular lubrication and hydraulic characteristics that are optimized for valve operation, use in torque converters, brake bands, and clutches. Apart from other measurable characteristics, the transmission fluid has a transmission fluid temperature and a viscosity that varies with the transmission fluid temperature. That is, the viscosity of the transmission fluid generally decreases (i.e. becomes less resistant to flow or becomes “thinner”) as the transmission fluid temperature increases. In a transmission, low viscosity is generally favored provided that sufficient performance of the transmission fluid is maintained, as high viscosity (i.e. where the transmission fluid is more resistant to flow or is “thicker”) leads to increased viscous drag-related losses within the transmission and an attendant decrease in efficiency. Stated another way, transmissions are most efficient when the transmission fluid is warmed to a target operating temperature. Rotation of the at least one gearset assembly creates friction which, in turn, produces heat. During operation, this heat warms the transmission fluid as the fluid is circulated through the at least one gearset assembly.

The relationship between the transmission fluid temperature and the efficiency of the transmission has become problematic in recent years due to an increasing desire for improved fuel economy in automobiles and other vehicles. Transmissions have been developed with a large number of forward gears to allow for engine downsizing. Smaller engines coupled to seven, eight, and nine speed transmissions are now commonplace. However, such smaller engines deliver less torque to the transmission meaning that it takes considerably longer for the transmission fluid in the transmission sump to warm up to the target operating temperature. Further, the packaging for transmissions with a large number of forward gears is typically larger in size and requires more transmission fluid than traditional transmissions that have four forward gears, for example. This increase in transmission fluid volume also increases the amount of time that it takes for the transmission fluid to warm up to the target operating temperature.

Finally, newer engines are now being equipped with engine start/stop features to improve fuel economy during city driving. Such features automatically turn the engine off when the vehicle is brought to rest and automatically start the engine again when the accelerator is pressed and travel is resumed. With no components of the transmission rotating when the vehicle is at rest and the engine is turned off, the transmission fluid rises more slowly when a vehicle equipped with the engine start/stop feature is brought to repeated stops during city driving. What this means is that transmissions in many modern cars are not operating a peak efficiency much of the time because the transmission fluid has not been elevated to the target operating temperature for most or all of a trip. The attendant viscous drag-related losses associated with low transmission fluid temperatures and thus a higher viscosity of the transmission fluid off-sets much of the efficiency gains that can be realized through engine downsizing and use of engine start/stop features.

With additional reference to FIG. 2, the dimensions of the transmission sump 22 are dependent upon the cavity 34, which has a horizontal extent, a vertical extent, and a total volumetric capacity. The housing 32 includes a bottom wall 36 (FIG. 1) and a side wall 38 that circumscribes the horizontal extent of the cavity 34 to define an open top 40 (FIG. 2). It should be appreciated that the bottom wall 36 and the side wall 38 of the housing 32 may be integrally formed as one piece. Further, the bottom wall 36 may be substantially flat as illustrated in the Figures or it may be contoured. The side wall 38 may be uniform, wrapping around the cavity 34 of the housing 32 or, alternatively, the side wall 38 may be comprised of a plurality of wall sections that are joined together. It should also be appreciated that the side wall 38 may be substantially vertical, as illustrated in the Figures. Alternatively, the side wall 38 may rise up at a fixed or at a variable angle with respect to the vertical. The horizontal extent of the cavity 34 may be described as a cross-sectional plane extending in two dimensions along a width W and a length L of the cavity 34. The vertical extent of the cavity 34 is bounded by the bottom wall 36 of the housing 32 and the open top 40. Accordingly, the vertical extent of the cavity 34 may be described as equaling a depth D of the cavity 34, which may vary depending on the shape of the bottom wall 36 of the housing 32. Generally and without limitation, the vertical extent of the cavity 34 in the transmission sump 22 ranges between approximately three (3) and four (4) inches. Thus, the vertical extent of the cavity 34 in the transmission sump 22 is significantly less than that of an engine oil sump, which may have a vertical extent of approximately seven (7) inches or more. A minimum transmission fluid level 42 is defined within the housing 32 as the level of transmission fluid 10 disposed in the cavity 34. The minimum transmission fluid level 42 may generally be measured when the vehicle is resting on a horizontal surface such that the transmission sump 22 is not tilted with respect to the horizontal. As such, the minimum transmission fluid level 42 is simply a measurement reflecting the minimum amount of transmission fluid 10 that remains in the cavity 34 when the transmission fluid 10 is circulating through the at least one gearset assembly 30.

With continued reference to FIG. 2, the transmission 24 also includes a suction tube 44 extending downwardly into the cavity 34 of the transmission sump 22 toward the bottom wall 36 of the housing 32. The suction tube 44 communicates the transmission fluid 10 from the transmission sump 22 to the at least one gearset assembly 30. The suction tube 44 has a proximal end 46 that extends beyond the open top 40 of the transmission sump 22 and a distal end 48 opposite the proximal end 46. The distal end 48 of the suction tube 44 may be spaced from the bottom wall 36 of the housing 32. A fluid pickup 50 is connected to the distal end 48 of the suction tube 44. Thus, the fluid pickup 50 is disposed within the cavity 34 of the housing 32 at or near the bottom wall 36 to draw in transmission fluid 10 from a region of the cavity 34 that is adjacent to the bottom wall 36. The fluid pickup 50 has a funnel shape with an inlet 52 facing the bottom wall 36 and an outlet 54 connected to the distal end 48 of the suction tube 44. The inlet 52 of the fluid pickup 50 has an inlet 52 diameter ID and the outlet 54 of the fluid pickup 50 has an outlet diameter OD that is smaller than the inlet diameter ID.

The transmission 24 further includes a pump 56 connected to the proximal end 46 of the suction tube 44. The pump 56 pulls the transmission fluid 10 from the transmission sump 22 via the fluid pickup 50 and through the suction tube 44 to supply the transmission fluid 10 to the at least one gearset assembly 30 for circulation therein. The transmission fluid 10 then returns to the transmission sump 22 in the form of droplets 35 falling from the at least one gearset assembly 30 under the influence of gravity.

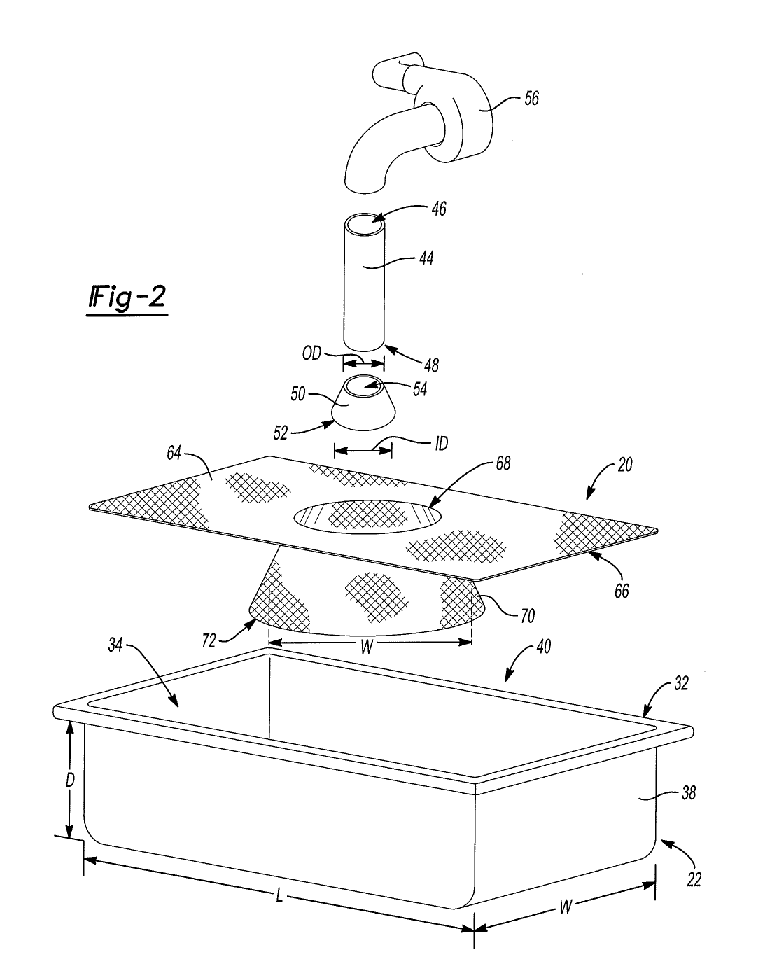

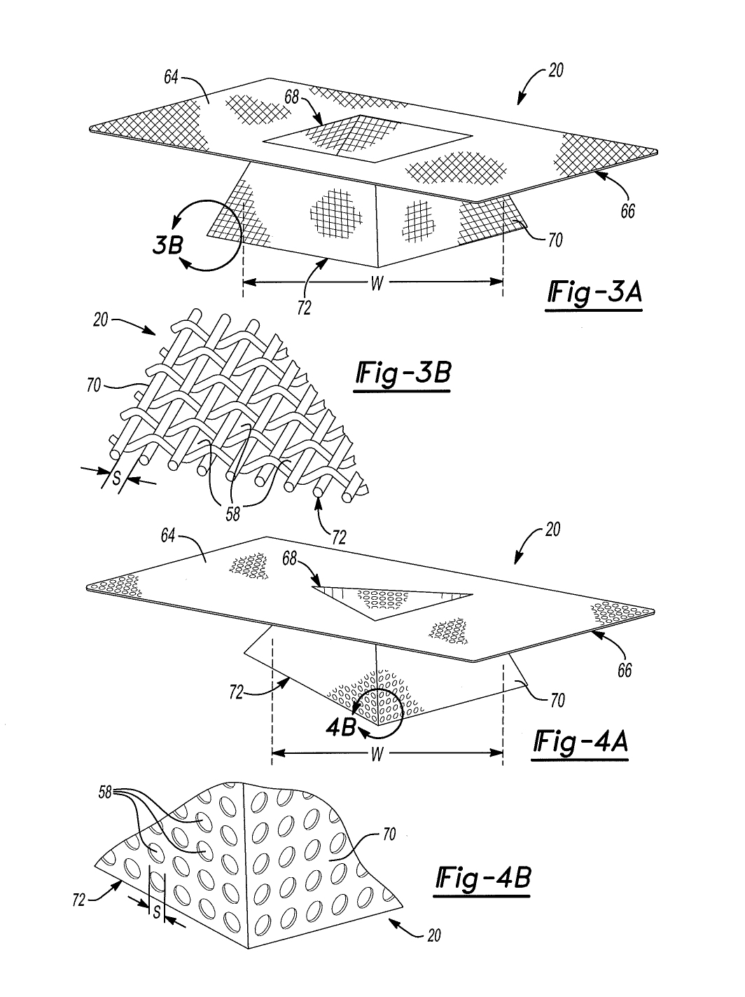

The transmission sump screen 20 is disposed generally within the transmission sump 22. As best seen in FIGS. 3B and 4B, the transmission sump screen 20 includes a mesh having discrete viscosity sensitive orifices 58, where each discrete viscosity sensitive orifice 58 has an orifice size S that gives the transmission sump screen 20 a predetermined permeability. The transmission fluid 10 cannot flow through the discrete viscosity sensitive orifices 58 in response to the transmission fluid temperature being below a threshold temperature. Referring again to FIG. 1, the transmission sump screen 20 selectively segregates the cavity 34 into a first volume 60 around the open top 40, suction tube 44, and fluid pickup 50 and a second volume 62 adjacent the side wall 38. When the transmission fluid temperature is below the threshold temperature, the transmission sump screen 20 acts as a barrier isolating the transmission fluid 10 contained within the second volume 62 from the transmission fluid 10 contained within the first volume 60. With the first volume 60 surrounding the fluid pickup 50, only the transmission fluid 10 contained within the first volume 60 is circulated at transmission fluid temperatures below the threshold temperature. Advantageously, the transmission fluid 10 contained within the first volume 60 is warmed to the operating temperature more quickly creating a hot zone of transmission fluid 10 within the first volume 60. The second volume 62 thus designates a cold zone and the transmission fluid 10 contained in the second volume 62 is not circulated until it reaches or exceeds the threshold temperature and can pass through the transmission sump screen 20 and to the fluid pickup 50 via the orifices 58. More particularly, the transmission sump screen 20 becomes permeable and the transmission fluid 10 contained in the second volume 62 can flow through the discrete viscosity sensitive orifices 58 of the transmission sump screen 20 in response to the transmission fluid temperature meeting or exceeding the threshold temperature. Accordingly, the total volumetric capacity of the cavity 34 is only utilized once the transmission fluid temperature of the transmission fluid 10 in the second volume 62 meets or exceeds the threshold temperature. It should further be noted that the transmission sump screen 20 may become semi-permeable at transmission fluid temperatures approaching the threshold temperature. Where the transmission sump screen 20 is semi-permeable, flow of transmission fluid 10 through the transmission sump screen 20 is restricted such that only limited amounts of transmission fluid 10 can passes through the transmission sump screen 20. Accordingly, it should be appreciated that the transmission sump screen 20 may not act as an open and closed valve at temperatures near the threshold temperature. Rather, the permeability of the transmission sump screen 20 may transition from a non-permeable state to a fully permeable state where a flow rate of the transmission fluid 10 passing through the transmission sump screen 20 gradually increases as the transmission sump screen 20 transitions from the non-permeable state to the fully permeable state.

The desired threshold temperature and the viscosity characteristics of the transmission fluid 10 influence the proper selection of the orifice size S of the discrete viscosity sensitive orifices 58. By way of example, the orifice size S selected for the transmission fluid 10 may range from approximately one millimeter to approximately two millimeters. Further, the discrete viscosity sensitive orifices 58 may take the form of a variety of shapes. By way of example only and without limitation, the discrete viscosity sensitive orifices 58 may be circular openings, square openings, rectangular openings, and/or triangular openings. As such, the discrete viscosity sensitive orifices 58 may be formed as holes in the transmission sump screen 20 as shown in FIG. 4B or simply defined by elements of the transmission sump screen 20 such as woven wire mesh as shown in FIG. 3B. Because the shape of the discrete viscosity sensitive orifices 58 may vary, the orifice size S may be defined in several ways. Where the discrete viscosity sensitive orifices 58 are circular, the orifice size S equals the diameter of the discrete viscosity sensitive orifices 58. Where the discrete viscosity sensitive orifices 58 are square, rectangular, or triangular, the orifice size S equals the length of the largest side of the discrete viscosity sensitive orifices 58. For any other shape of the discrete viscosity sensitive orifices 58, the orifice size S equals the diameter of the largest circle that fits within one of the discrete viscosity sensitive orifices 58.

The threshold temperature is selected to correspond with the target operating temperature of the transmission fluid 10. By way of example and without limitation, the threshold temperature may range from approximately ten degrees Celsius (10° C.) to approximately sixty degrees Celsius (60° C.). Generally, for a given transmission fluid 10, the orifice size S corresponding to the threshold temperature of ten degrees Celsius (10° C.) will be larger than the orifice size S corresponding to the threshold temperature of sixty degrees Celsius (60° C.). Similarly, for a given threshold temperature, the orifice size S will be greater for a transmission fluid 10 that has a higher viscosity at the threshold temperature than for a transmission fluid 10 that has a lower viscosity at the threshold temperature.

With reference to FIGS. 1 and 2, the transmission sump screen 20 generally includes a first portion 64. The first portion 64 of the transmission sump screen 20 includes an outside edge 66 abutting the side wall 38 and an inner edge 68 inwardly spaced from the outside edge 66. More particularly, the inner edge 68 may be disposed about the suction tube 44 such that the inner edge 68 is spaced about and circumscribes the suction tube 44. The inner edge 68 defines a neck region 26 of the first volume 60 that generally corresponds to the narrowest cross-section of the first volume 60. The neck region 26 of the first volume 60 has a first periphery equaling the length or perimeter of the inner edge 68. The first portion 64 of the transmission sump screen 20 spans the horizontal extent of the cavity 34 below the minimum transmission fluid level 42 of the housing 32 to define an upper region 27 of the first volume 60. The first portion 64 of the transmission sump screen 20 directs circulating transmission fluid 10 in the upper region 27 of the first volume 60 toward the neck region 26 of the first volume 60 in response to the transmission fluid temperature being below the threshold temperature. Accordingly, the neck region 26 of the first volume 60 is disposed between the upper region 27 and the lower region 28. Although other shapes are considered within the scope of the present disclosure, the first portion 64 of the transmission sump screen 20 may generally be flat to create a pool of transmission fluid 10 in the upper region 27 of the first volume 60 across the entire horizontal extent of the cavity 34 above the first portion 64 of the transmission sump screen 20 to collect falling droplets 35 of transmission fluid 10.

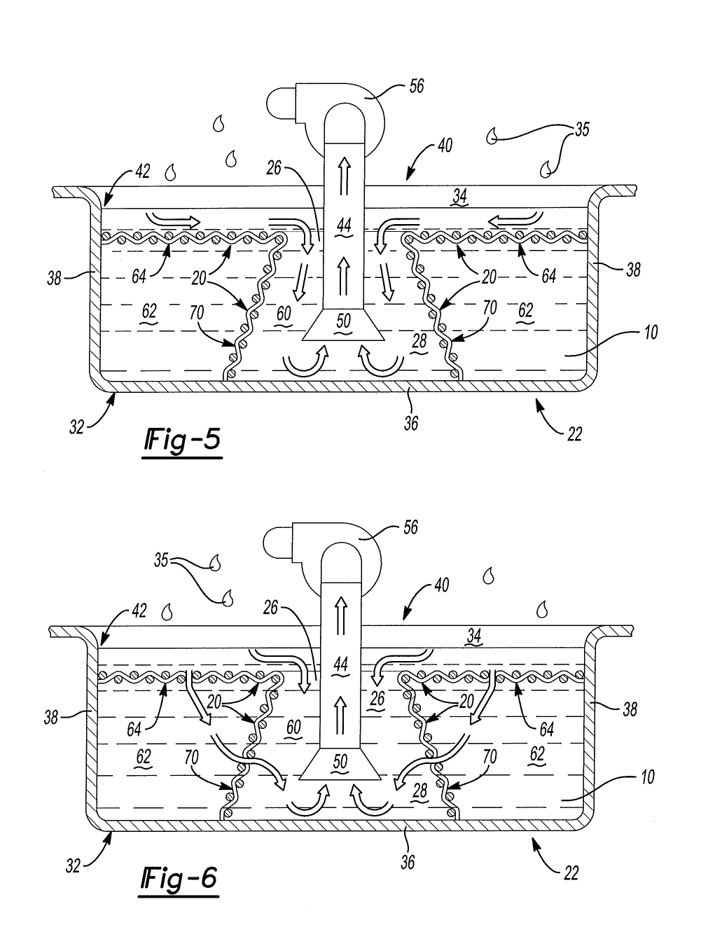

The transmission sump screen 20 further includes a second portion 70 extending downwardly and outwardly from the inner edge 68 of the first portion 64 to a lower edge 72 abutting the bottom wall 36. The second portion 70 of the transmission sump screen 20 thus defines a lower region 28 of the first volume 60 that has a second periphery equaling the length or perimeter of the lower edge 72. The second periphery of the lower region 28 of the first volume 60 is larger than the first periphery of the neck region 26 of the first volume 60. The lower region 28 of the first volume 60 has a cross-sectional width W that increases gradually from the inner edge 68 to the lower edge 72. This cross-sectional width W is measured parallel to the horizontal extent of the cavity 34. Accordingly, the first volume 60 gets wider moving down from the neck region 26 towards the bottom wall 36. In this way, the second portion 70 of the transmission sump screen 20 directs circulating transmission fluid 10 through the first volume 60 and toward the fluid pickup 50 when the transmission fluid temperature is below the threshold temperature, as indicated by the arrows shown in FIG. 5.

While the lower region 28 of the first volume 60 may take a variety of shapes without departing from the scope of this disclosure, in one exemplary configuration, the lower region 28 of the first volume 60 generally has a frustoconical shape as shown in FIG. 2. In accordance with this configuration, the second portion 70 of the transmission sump screen 20 extends downwardly at a constant angle Ø (FIG. 1) with respect to the first portion 64 of the transmission sump screen 20. The constant angle Ø is an acute angle, which may be, without limitation, in the range of 30 degrees to 85 degrees. In another exemplary configuration, the lower region 28 of the first volume 60 is shaped as a three-sided or four-sided pyramid, as shown in FIGS. 3A and 4A. In accordance with these configurations, the second portion 70 of the transmission sump screen 20 also extends downwardly at the constant angle Ø with respect to the first portion 64 of the transmission sump screen 20. Obviously, other shapes may be employed and the above examples are not limiting in anyway. It should also be appreciated that use of the terms first portion 64 and second portion 70 to describe the transmission sump screen 20 generally identify general segments or areas of the transmission sump screen 20 and do not necessary imply separate and discrete parts. It is envisioned that the first portion 64 and the second portion 70 of the screen 20 may be integrally formed or may alternatively be separate pieces that are joined together to form the transmission sump screen 20. Further, in other possible configurations, the second portion 70 of the transmission sump screen 20 may not conform to the constant angle Ø as the second portion 70 may alternatively be flared, curved, or stepped.

Advantageously, the widening geometry of the lower region 28 of the first volume 60, as defined by the second portion 70 of the transmission sump screen 20, provides the first volume 60 with sufficient volumetric capacity adjacent the fluid pickup 50 despite the limited vertical extent (i.e. shallowness) of the transmission sump 22. This ensures proper transmission fluid 10 circulation and reduces the likelihood of pick-up starvation even under conditions where the transmission 24 is tilted with respect to the horizontal or subject to accelerational forces due to vehicle acceleration, braking, and/or cornering.

Now referring to FIG. 5, the transmission sump 22 is illustrated where the transmission fluid 10 in the cavity 34 has not yet reached the threshold temperature. The first volume 60 contains transmission fluid 10 circulating through the at least one gearset assembly 30 (shown in FIG. 1) to create a hot zone of transmission fluid 10 within the transmission sump 22 that is co-extensive with the first volume 60. The second volume 62 contains transmission fluid 10 that is isolated from the first volume 60 until the transmission fluid temperature of the transmission fluid 10 in the second volume 62 meets or exceeds the threshold temperature. This creates a cold zone of transmission fluid 10 within the transmission sump 22 that is co-extensive with the second volume 62. The transmission fluid 10 in the second volume 62 cannot flow through the transmission sump screen 20 until it warms to a transmission fluid temperature at or above the threshold temperature because the viscosity of the transmission fluid 10 is too great for the transmission fluid 10 to flow through the discrete viscosity sensitive orifices 58 of the transmission sump screen 20 at transmission fluid temperatures below the threshold temperature. Accordingly, only transmission fluid 10 located in the first volume 60 may be drawn into the fluid pickup 50 for circulation through the at least one gearset assembly 30. The transmission fluid 10 is then warmed by friction during circulation through the at least one gearset assembly 30 and returns to the first volume 60 by falling in the form of droplets 35 into the cavity 34 of the transmission sump 22 under the influence of gravity. The time it takes a discrete molecule of transmission fluid 10 to circulate through the at least one gearset assembly 30 is called residence time. The residence time also equals the amount of time a discrete molecule of transmission fluid 10 remains in the transmission sump 22 because the minimum transmission fluid level 42 in the transmission sump 22 is maintained as the transmission fluid 10 is circulated. Stated another way, the residence time is the amount of time it takes for all of the transmission fluid 10 in the cavity 34 to be renewed.

Still referring to FIG. 5, the transmission fluid 10 that has been warmed during circulation in the at least one gearset assembly 30 collects in the pool located in the upper region 27 of the first volume 60 (i.e. above the first portion 64 of the transmission sump screen 20). From there, the transmission sump screen 20 directs the transmission fluid 10 through the neck region 26 of the first volume 60 and into the lower region 28 of the first volume 60 where it may again be drawn into the fluid pickup 50 for circulation. The first volume 60 has a volumetric capacity that is selected to achieve a short residence time. This short residence time allows for the transmission fluid 10 in the first volume 60 to be warmed more rapidly. By way of example and without limitation, volumetric capacity of the first volume 60 is selected to achieve a residence time ranging from approximately one-half of one (1) second to approximately one and one-half (1.5) seconds. Accordingly, the transmission fluid 10 contained in the first volume 60 is warmed first which, in turn, gradually warms the adjacent transmission fluid 10 contained in the second volume 62. The second volume 62 has a volumetric capacity selected to achieve a longer residence time for when the transmission fluid 10 has been raised to or above the target operating temperature. By way of example and without limitation, volumetric capacity of the second volume 62 is selected to achieve a residence time ranging from approximately two and one-half (2.5) seconds to approximately three and one-half (3.5) seconds.

Now referring to FIG. 6, the transmission sump 22 is illustrated where all of the transmission fluid 10 in the cavity 34 has reached the threshold temperature. Both the first volume 60 and second volume 62 contain transmission fluid 10 circulating through the at least one gearset assembly 30 (shown in FIG. 1) creating a hot zone of transmission fluid 10 within the entire cavity 34 of the housing 32. The transmission fluid 10 readily flows through the discrete viscosity sensitive orifices 58 in the screen 20 such that the transmission fluid 10 circulates between the first volume 60 and the second volume 62, as indicated by the arrows shown in FIG. 6. The transmission fluid 10 returns initially to the first volume 60 by falling in the form of droplets 35 into the cavity 34 of the transmission sump 22 under the influence of gravity. From there, the transmission fluid 10 either flows directly through the first volume 60 to the fluid pickup 50 or passes through the transmission sump screen 20 from the first volume 60 to the second volume 62 and back to the first volume 60 where the fluid pickup 50 is located.

The foregoing description of the embodiments has been provided for the purposes of illustration and description. It is not intended to be exhaustive or limiting. Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility.

What is claimed is:

1. A transmission sump comprising:
a housing including a bottom wall and a side wall defining a cavity within said housing with an open top;
a fluid pickup disposed within said cavity that draws transmission fluid from a region adjacent said bottom wall;
a transmission sump screen presenting a mesh of viscosity sensitive orifices, said transmission sump screen having a predetermined permeability that is defined by said mesh of viscosity sensitive orifices such that said transmission sump screen selectively segregates said cavity of said housing into a first volume around said fluid pickup and a second volume adjacent said side wall depending upon transmission fluid temperature;
said transmission sump screen including a first portion having an outside edge abutting said side wall and an inner edge inwardly spaced from said side wall, said first portion of said transmission sump screen defining a neck region of said first volume that has a first periphery; and
said transmission sump screen including a second portion extending downwardly from said inner edge of said first portion of said transmission sump screen to a lower edge abutting said bottom wall, said second portion of said transmission sump screen defining a lower region of said first volume that has a second periphery that is larger than said first periphery such that said first volume is narrower at said neck region relative to said lower region.

2. A transmission sump as set forth in claim 1 wherein said transmission sump screen has a cross-sectional width that increases moving from said inner edge of said first portion to said lower edge of said second portion.

3. A transmission sump as set forth in claim 2 wherein said second portion of said transmission sump screen extends downwardly and outwardly at an acute angle with respect to said first portion of said transmission sump screen.

4. A transmission sump as set forth in claim 1 wherein said lower region of said second volume has a frustoconical shape.

5. A transmission sump as set forth in claim 1 wherein said lower region of said second volume is shaped as a three-sided pyramid.

6. A transmission sump as set forth in claim 1 wherein said lower region of said second volume is shaped as a four-sided pyramid.

7. A transmission sump as set forth in claim 1 wherein said housing has a minimum transmission fluid level and said first portion of said transmission sump screen spans said horizontal extent of said cavity below said minimum transmission fluid level to define an upper region of said first volume above said first portion of said transmission sump screen.

8. A transmission sump as set forth in claim 1 wherein said discrete viscosity sensitive orifices of said transmission sump screen each have an orifice size selected to prevent flow of transmission fluid from said second volume through said transmission sump screen and into said first volume when said transmission fluid temperature is below a threshold temperature.

9. A transmission sump as set forth in claim 8 wherein said orifice size is 1 millimeter to 2 millimeters.

10. A transmission sump as set forth in claim 8 wherein said transmission sump screen is permeable to transmission fluid when said transmission fluid temperature equals and exceeds said threshold temperature.

11. A transmission sump as set forth in claim 8 wherein said threshold temperature is associated with a target operating temperature of transmission fluid.

12. A transmission sump as set forth in claim 1 further including a suction tube extending through said first volume and connecting to said fluid pickup that communicates transmission fluid from said cavity of said housing.

13. A transmission sump as set forth in claim 12 wherein said inner edge of said first portion of said transmission sump screen is spaced about and circumscribes said suction tube adjacent said neck region of said first volume.

14. A transmission sump as set forth in claim 1 wherein said cavity has a vertical extent bounded by said bottom wall of said housing and said open top and wherein said vertical extent of said cavity ranges from 3 inches to 4 inches.

15. An apparatus for disposition in a transmission sump comprising:
a transmission sump screen presenting a mesh of viscosity sensitive orifices;
said transmission sump screen having a predetermined permeability that is defined by said mesh of viscosity sensitive orifices such that said transmission sump screen selectively segregates the transmission sump into a first volume and a second volume depending upon transmission fluid temperature;
said transmission sump screen including a first portion having an outside edge abutting the transmission sump and an inner edge inwardly spaced from said outside edge;
said first portion of said transmission sump screen defining a neck region of said first volume that has a first periphery;
said transmission sump screen including a second portion extending downwardly from said inner edge of said first portion of said transmission sump screen to a lower edge abutting the transmission sump; and
said second portion of said transmission sump screen defining a lower region of said first volume that has a second periphery wherein said second periphery of said lower region of said first volume is larger than said first periphery of said neck region of said first volume such that said first volume is narrower at said neck region relative to said lower region.

16. An apparatus as set forth in claim 15 wherein said discrete viscosity sensitive orifices each have an orifice size selected to prevent flow of transmission fluid from said second volume to said first volume when said transmission fluid temperature is below a threshold temperature.

17. An apparatus as set forth in claim 16 wherein said mesh of viscosity sensitive orifices is permeable to transmission fluid when said transmission fluid temperature equals and exceeds said threshold temperature.

18. An apparatus as set forth in claim 17 wherein said threshold temperature ranges from 10 degrees Celsius to 60 degrees Celsius.

19. An apparatus as set forth in claim 16 wherein said orifice size of said discrete viscosity sensitive orifices ranges from 1 millimeter to 2 millimeters.

20. An apparatus as set forth in claim 16 wherein the transmission sump has a residence time for transmission fluid and said first volume has a volumetric capacity selected to reduce said residence time when said transmission fluid temperature is below said threshold temperature relative to said residence time of the transmission sump when said transmission fluid temperature is above said threshold temperature and transmission fluid is flowing through both said first volume and said second volume.

21. An apparatus as set forth in claim 20 wherein said volumetric capacity of said first volume is selected such that said residence time in the transmission sump ranges from 0.5 seconds to 1.5 seconds when said transmission fluid temperature is below said threshold temperature.

22. An apparatus as set forth in claim 20 wherein said second volume has a volumetric capacity selected such that said residence time in the transmission sump ranges from 2.5 seconds to 3.5 seconds when said transmission fluid temperature is above said threshold temperature.

23. A transmission for use in a vehicle comprising:
at least one gearset assembly including a plurality of gears;
a transmission sump disposed beneath said at least one gearset assembly;
said transmission sump including a housing including a bottom wall and a side wall defining a cavity within said transmission sump;
said cavity having an open top such that said cavity collects transmission fluid after the transmission fluid is circulated within said at least one gearset assembly;
a suction tube extending downwardly into said cavity of said transmission sump toward said bottom wall of said housing that transports the transmission fluid from said transmission sump to said at least one gearset assembly;
a pump connected to said suction tube that pulls the transmission fluid from said transmission sump and supplies the transmission fluid to said at least one gearset assembly;
a transmission sump screen presenting a mesh of discrete viscosity sensitive orifices having an orifice size, said transmission sump screen having a predetermined permeability where the transmission fluid cannot flow through said discrete viscosity sensitive orifices in response to said transmission fluid temperature being below a threshold temperature and where the transmission fluid can flow through said discrete viscosity sensitive orifices in response to said transmission fluid temperature exceeding said threshold temperature;
said transmission sump screen including a first portion and a second portion that divide said cavity into a first volume around said open top, said suction tube, and said fluid pickup and a second volume disposed adjacent to said side wall;
said first portion of said transmission sump screen including an outside edge abutting said side wall and an inner edge spaced about and circumscribing said suction tube, said inner edge defining a neck region of said first volume having a first periphery;
said first portion of said transmission sump screen extending horizontally across said cavity below a minimum transmission fluid level of said housing such that said first portion of said transmission sump screen is submersed in the transmission fluid and directs the transmission fluid returning to the transmission sump toward said neck region of said first volume when said transmission fluid temperature is below said threshold temperature;
said second portion of said transmission sump screen extending downwardly and outwardly from said inner edge of said first portion to a lower edge abutting said bottom wall to such that said second portion of said transmission sump screen directs the transmission fluid in said first volume toward said fluid pickup when said transmission fluid temperature is below said threshold temperature;
said second portion of said transmission sump screen defining a lower region of said first volume where said lower region of said first volume has a second periphery that is larger than said first periphery of said neck region such that said first volume is narrower at said neck region relative to said lower region; and
said transmission sump screen separating the transmission fluid contained in said first volume from the transmission fluid contained in said second volume until the transmission fluid temperature of the transmission fluid in said second volume exceeds said threshold temperature.

24. An apparatus for disposition in a transmission sump comprising:
a transmission sump screen presenting a mesh of viscosity sensitive orifices;
said transmission sump screen having a predetermined permeability that is defined by said mesh of viscosity sensitive orifices such that said transmission sump screen selectively segregates the transmission sump into a first volume and a second volume depending upon transmission fluid temperature;
said transmission sump screen including a first portion having an outside edge abutting the transmission sump and an inner edge inwardly spaced from said outside edge;
said transmission sump screen including a second portion extending downwardly from said inner edge of said first portion of said transmission sump screen to a lower edge abutting the transmission sump; and
each viscosity sensitive orifice in said mesh of viscosity sensitive orifices having an orifice size selected to prevent flow of transmission fluid from said second volume to said first volume when said transmission fluid temperature is below a threshold temperature, wherein said orifice size is 1 millimeter to 2 millimeters.
